(19) United States
(12) Patent Application Publication
(10) Pub. No.: US 2025/0019841 A1
(43) Pub. Date: Jan. 16, 2025

(54) CATALYST SUPPORT MATERIALS FOR ELECTROCHEMICAL CELLS

(71) Applicant: Robert Bosch GmbH, Stuttgart (DE)

(72) Inventors: Soo KIM, Arlington, MA (US); Lei CHENG, San Jose, CA (US); Jonathan MAILOA, Cambridge, MA (US); Sarah STEWART, San Carlos, CA (US); Christina JOHNSTON, Spanish Fort, AL (US); Charles TUFFILE, Swansea, MA (US); Jake CHRISTENSEN, Elk Grove, CA (US)

(21) Appl. No.: 18/707,017

(22) PCT Filed: Nov. 2, 2021
(86) PCT No.: PCT/US2021/057640

§ 371 Date: May 2, 2024

(51) Int. Cl. C25B 11/056; C25B 11/067; C25B 11/081; H01M 4/92

(52) U.S. Cl. CPC C25B 11/056; C25B 11/067; C25B 11/081; H01M 4/925

(57) ABSTRACT

An electrochemical cell catalyst support includes a fibrous catalyst support material. The fibrous catalyst support material includes a mixed metal oxide material of magnesium (Mg) and titanium (Ti) with a general formula of MgₐTi_{b}O₅₋ₓ, where 0≤x≤3, and a ratio of a to b is greater than 0.01 and less than 0.8.

### CROSS-REFERENCE TO RELATED APPLICATIONS

This application is the U.S. national phase of PCT Application No. PCT/US2021/057640 filed Nov. 2, 2021, the disclosure of which is incorporated in its entirety by reference herein.

### TECHNICAL FIELD

The present disclosure relates to catalyst support materials for electrochemical cells, for example, catalyst support materials for fuel cells or electrolyzers.

### BACKGROUND

An electrochemical cell is a device capable of either generating electrical energy from chemical reactions (e.g. fuel cells) or using electrical energy to conduct chemical reactions (e.g. electrolyzers). Specifically, fuel cells have shown promise as an alternative power source for vehicles and other transportation applications. Fuel cells operate with a renewable energy carrier, such as hydrogen. Fuel cells also operate without toxic emissions or greenhouse gases. One of the current limitations of widespread adoption and use of this clean and sustainable technology is the relatively expensive cost of the fuel cell. A catalyst material (e.g. platinum catalyst) is included in both the anode and cathode catalyst layers of a fuel cell. The catalyst material is one of the most expensive components in the fuel cell.

Electrolyzers undergo an electrolysis process to split water into hydrogen and oxygen, providing a promising method for hydrogen generation from renewable resources. An electrolyzer, like a fuel cell, includes an anode and cathode catalyst layers separated by an electrolyte membrane. The electrolyte membrane may be a polymer, an alkaline solution, or a solid ceramic material. A catalyst material is included in the anode and cathode catalyst layers of the electrolyzer.

### SUMMARY

According to one embodiment, an electrochemical cell catalyst support is disclosed. The electrochemical cell catalyst support may include a fibrous catalyst support material. The fibrous catalyst support material may be a mixed metal oxide material of magnesium (Mg) and titanium (Ti) with a general formula of MgₐTi_{b}O₅₋ₓ, where 0≤x≤3, and a ratio of a to b is greater than 0.01 and less than 0.8.

According to another embodiment, an electrochemical cell catalyst layer is disclosed. The electrochemical cell catalyst layer may include a catalyst material and a catalyst support supporting the catalyst material. The catalyst support may include a catalyst support material. The catalyst support material may be a mixed metal oxide material of magnesium (Mg) and titanium (Ti) with a general formula of MgₐTi_{b}O₅₋ₓ, where 0≤x≤3, and a ratio of a to b is not 0.5. The catalyst support material may have a fibrous structure.

According to yet another embodiment, an electrochemical cell is disclosed. The electrochemical cell may include a first catalyst layer and a second catalyst layer. Each of the first and second catalyst layers may have a catalyst support supporting a catalyst material. The catalyst support may have a catalyst support material. The catalyst support material may be a mixed metal oxide material of magnesium (Mg) and titanium (Ti) with a general formula of MgₐTi_{b}O₅₋ₓ, where 0≤x≤3, and a ratio of a to b is not 0.5. The catalyst support material may have a fibrous structure. The electrochemical cell may further includer an electrolyte membrane situated between the first and second catalyst layers.

### BRIEF DESCRIPTION OF THE DRAWINGS

FIG. 1 depicts a schematic diagram showing an effective target conductivity (σ, S/cm) of an oxide material as a function of an overpotential budget (η, V).

FIG. 2 depicts a schematic diagram showing an effective target conductivity (σ, S/cm) of an oxide material as a function of a current density (J, A/cm²) under different overpotential budgets.

FIG. 3A depicts a calculated X-ray diffraction (XRD) pattern for orthorhombic MgTi₂O₅(Cmcm) phases.

FIG. 3B depicts a calculated X-ray diffraction (XRD) pattern for orthorhombic Ti₂O₃(R-3c) phases.

FIG. 4A depicts a schematic diagram of a first embodiment of a catalyst layer.

FIG. 4B depicts a schematic diagram of a second embodiment of a catalyst layer.

FIG. 5A is a schematic cross-sectional view of a fuel cell according to one embodiment of the present disclosure.

FIG. 5B is a schematic perspective view of components of the fuel cell shown in FIG. 5A.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for applications or implementations.

This present disclosure is not limited to the specific embodiments and methods described below, as specific components and/or conditions may, of course, vary. Furthermore, the terminology used herein is used only for the purpose of describing embodiments of the present disclosure and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed.

Except where expressly indicated, all numerical quantities in this description indicating dimensions or material properties are to be understood as modified by the word “about” in describing the broadest scope of the present disclosure.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

The term “substantially” may be used herein to describe disclosed or claimed embodiments. The term “substantially” may modify any value or relative characteristic disclosed or claimed in the present disclosure. “Substantially” may signify that the value or relative characteristic it modifies is within ±0%, 0.1%, 0.5%, 1%, 2%, 3%, 4%, 5% or 10% of the value or relative characteristic.

Reference is being made in detail to compositions, embodiments, and methods of embodiments known to the inventors. However, disclosed embodiments are merely exemplary of the present disclosure which may be embodied in various and alternative forms. Therefore, specific details disclosed herein are not to be interpreted as limiting, rather merely as representative bases for teaching one skilled in the art to variously employ the present disclosure.

Electrochemical cells show great potential as an alternative solution for energy production and consumption. Particularly, fuel cells are being developed as electrical power sources for automobile applications, and electrolyzers are being used for hydrogen production from renewal resources (e.g. water). However, widespread adoption of the electrochemical cells requires further research into lifetime and cost reduction for components used in the electrochemical cells. These components include an electrolyte membrane and catalyst layers separated by the electrolyte membrane.

A typical single polymer electrolyte membrane (PEM) fuel cell is composed of a PEM, an anode layer, a cathode layer, and GDLs. These components form a membrane electrode assembly (MEA), which is surrounded by two flow field plates. A catalyst material, such as platinum (Pt) catalysts, is included in the anode and cathode layers of the PEM fuel cell. At the anode layer, Pt catalysts catalyze a hydrogen oxidation reaction (HOR, H₂→2H⁺+2e⁻), where H₂ is oxidized to generate electrons and protons (H⁺). At the cathode layer, Pt catalysts catalyze an oxygen reduction reaction (ORR, ½O₂+2H⁺+2e⁻→H₂O), where O₂ reacts with H⁺ and is reduced to form water.

A typical single electrolyzer is composed of an electrolyte membrane, an anode layer, and a cathode layer separated from the anode layer by the electrolyte membrane. A catalyst material, such as Pt catalysts, is included in the anode and cathode layers of the electrolyzer. At the anode layer, H₂O is hydrolyzed to O₂ and H⁺ (2H₂O→O₂+4H⁺+4e⁻). At the cathode layer, H⁺ combines with electrons to form H₂ (4H⁺+4e⁻→2H₂).

Traditional catalyst support materials for the catalyst layers (i.e. anode and cathode layers) of an electrochemical cell have been involved with carbon-based materials, such as carbon blacks or conductive, amorphous carbons. Researchers have recently developed alternative catalyst support materials, including metal oxides. The electronic conductivity of a catalyst support material may impact electrochemical cell operations. For example, if the electronic conductivity of the catalyst support material is too low, the catalyst support material may exhibit an enhanced Ohmic resistance, which consequently leads to a significant voltage loss during an electrochemical cell operation. Such an adverse effect may become worse when the electrochemical cell operates at a high current density (e.g. above 1 A/cm²). For example, niobium (Nb)-tin oxide (SnO₂) has been studied to be used as a catalyst support material for supporting Pt catalysts. However, the ohmic resistance of Pt/Nb—SnO₂ is two to three times greater than that of Pt/C. Particularly, when a fuel cell operates at a high current density (J), such as J=2 A/cm², a voltage loss due to the increased Ohmic resistance of Pt/Nb—SnO₂ may be about 0.5 V. Comparatively, when the fuel cell uses a carbon-based catalyst support material, a voltage loss may be about 0.2 V. The resulting 0.3 V overpotential may significantly influence the operation and durability of the fuel cell.

As such, there is a need for an electrochemical cell (e.g. a fuel cell or electrolyzer) catalyst support material that may exhibit great electronic conductivity, even when the electrochemical cell operates at a high current density. Aspects of the present disclosure are directed to catalyst support materials for electrochemical cells, for example, catalyst support materials for fuel cells or electrolyzers. The catalyst support material may be a mixed metal oxide material of magnesium (Mg) and titanium (Ti) with a general formula of MgₐTi_{b}O₅₋ₓ, where 0≤x≤3, and a and b are different.

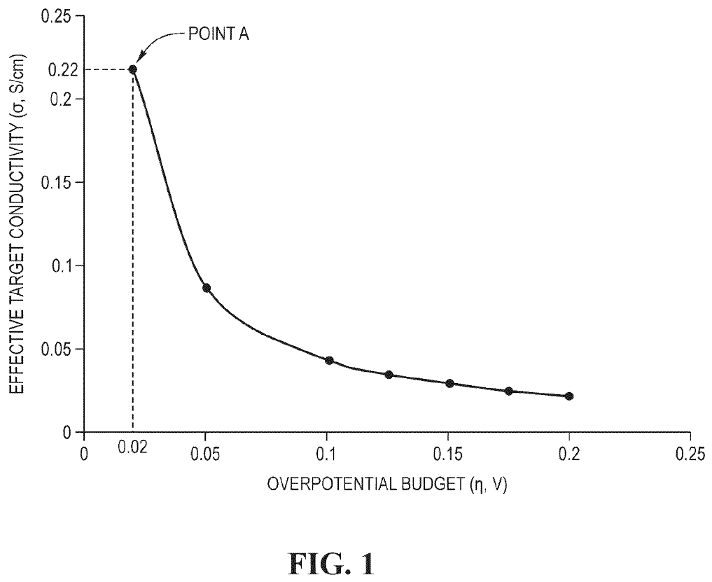

FIG. 1 depicts a schematic diagram showing an effective target conductivity (σ, S/cm) of an oxide material as a function of an overpotential budget (η, V). The oxide material may be a mixed metal oxide material of metal elements. The metal elements may be magnesium (Mg) and titanium (Ti). The oxide material may be a used as a catalyst support material for an electrochemical cell. The diagram shown in FIG. 1 is yielded when a current density J is kept at 2 A/cm², and when an electrode thickness (t, μm) is 10 μm. As shown in FIG. 1, as the overpotential budget increases, the effective target conductivity of the oxide material decreases.

A method of calculating an effective target conductivity (σ) of an inorganic material and/or an overpotential budget (η) is described. The inorganic material may be an oxide material. The oxide material may be a mixed metal oxide material of metal elements. The metal elements may be magnesium (Mg) and titanium (Ti). The method may be used to calculate the effective target conductivity of the oxide material and/or the overpotential budget as shown in FIG. 1. As an example, the method of calculating the effective target conductivity of the oxide material and/or the overpotential budget at Point A is described. At Point A, suppose the overpotential budget is known; that is, η=0.02 V. As such, an electron resistance budget (R, ohm-cm²) at Point A may be calculated using formula (1):

R=η/J (1)

Because the current density is 2 A/cm², the electron resistance budget at Point A thus equals 0.02/2, which is 0.01 ohm-cm². Thereafter, based on the calculated electron resistance budget at Point A, an electron conductivity budget (σₑ, S/cm) at Point A may be calculated using formula (2):

σₑ=t_{1/2}*0.0001/R (2)

where t_{1/2} represents one half of the electrode thickness. Because the electrode thickness t is 10 μm, t_{1/2} thus equals 5 μm. Using formular (2), the electron conductivity budget at Point A equals 5*0.0001/0.01, which is 0.05 S/cm.

Next, a target bulk conductivity (σ_{b}, S/cm) of the oxide material at Point A may be calculated using formula (3):

σ_{b}=σₑ/(χₛ)^{α} (3)

where χₛ represents a volume fraction of the oxide material, and χₛ equals 0.3; α represents a Bruggeman exponent, and α equals 1.5. Therefore, the target bulk conductivity of the oxide material equals 0.05/0.3^{1.5}, which is about 0.30 S/cm.

Based on the calculated target bulk conductivity, the effective target conductivity (σ, S/cm) of the oxide material at Point A may be calculated using formula (4):

σ=σ_{b}*(χₚ)^{α} (4)

where χₚ represents a Pellet volume fraction of the oxide material, and χₚ equals 0.8; α represents the Bruggeman exponent, and α equals 1.5. Therefore, the effective target conductivity σ of the oxide material equals 0.30*0.8^{1.5}, which is about 0.22 S/cm.

As such, when an overpotential budget is known, an effective target conductivity of the oxide material may be calculated following formulas (1) to (4). Similarly, if an effective target conductivity of the oxide material is known, an overpotential budget may also be calculated based on formulas (1) to (4).

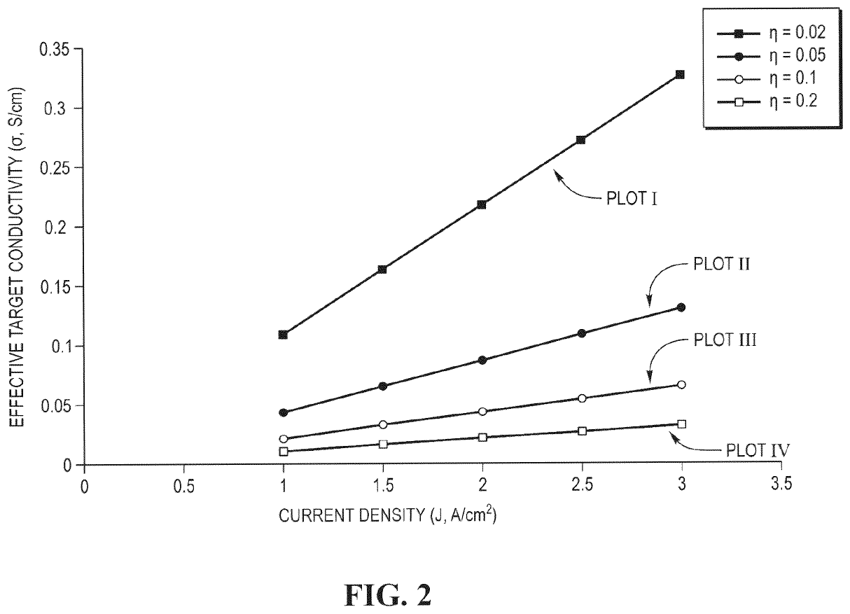

FIG. 2 depicts a schematic diagram showing an effective target conductivity (σ, S/cm) of an oxide material as a function of a current density (J, A/cm²) under different overpotential budgets. The oxide material may be a mixed metal oxide material of metal elements. The metal elements may be Mg and Ti. The oxide material may be used as a catalyst support material for an electrochemical cell. FIG. 2 exhibits the diagram when the current density is relatively high, for example, J>1 A/cm². Plot I shows an effective target conductivity of the oxide material as a function of a current density when the overpotential budget is 0.02 V. Plot II shows an effective target conductivity of the oxide material as a function of a current density when the overpotential budget is 0.05 V. Plot III shows an effective target conductivity of the oxide material as a function of a current density when the overpotential budget is 0.1 V. Plot IV shows an effective target conductivity of the oxide material as a function of a current density when the overpotential budget is 0.2 V.

Referring to FIG. 2, at a certain current density, the effective target conductivity of the oxide material appears to decrease when the overpotential budget increases, which is consistent with the observation in FIG. 1. When the effective target conductivity of the oxide material is about 0.1 S/cm, the current density may be 1 A/cm² when an overpotential budget is 0.02 V; or the current density may be 2.5 A/cm² when an overpotential budget is 0.05 V. It appears that the minimum effective target conductivity is greater than 0.01 S/cm because, for a given overpotential budget, the effective target conductivity of the oxide material increases as the current density increases. Even when the effective target conductivity is 0.01 S/cm, it appears that the overpotential budget is at least 0.2 V.

To deposit electrochemical cell catalyst materials on a catalyst support, the catalyst support may need to be prepared in nanosized particles, for example, when the catalyst support includes an oxide catalyst support material. The oxide catalyst support material may be a mixed metal oxide material of a first metal element and a second metal element. The first metal element may be Mg. The second metal element may be Ti. The electrochemical cell catalyst material may be Pt and/or Pt-M, where M is a metal element other than Pt. The size of the catalyst materials may be in a range of 2 to 9 nm. In some embodiments, the size of the catalyst materials may be in a range of 4 to 8 nm.

When the oxide catalyst support material is prepared as nanosized particles, it is possible that the grain boundaries between the nanosized particles that are in contact with each other may lead to an increase internal resistance, thereby causing a decrease in the overall electronic conductivity of the catalyst support material. One way to mitigate such a resistance, the oxide catalyst support material may be prepared as a fibrous structure. The fibrous structure may allow electrons to pass along an axial direction thereof, without crossing the nanosized particles. In some embodiments, the fibrous structure may be nanofibers. In some other embodiments, the fibrous structure may be microfibers.

A method of synthesizing a catalyst support material is described. The catalyst support material may be an oxide material. The oxide material may be a mixed metal oxide material of metal elements. The mixed metal oxide material of metal elements may be prepared as a fibrous structure, such as nanofibers or microfibers.

In one embodiment, metal-containing precursors (e.g. a first and second metal-containing compounds) may be drawn into long strands or fibers, followed by a heat treatment in a reducing or oxidizing environment at a medium to high temperature (e.g. 200 to 2,000° C.) to generate a fibrous structure. The heat treatment may help remove precursor impurities, such as nitric oxide (NOx), chloride (Cl), carbonate (CO₃), or oxalate (C₂O₄), leaving metal elements in the fibrous structure. Due to the medium to high temperature, the impurities may exist in a gas form. After the heat treatment, the fibrous structure may go through one or more chemical and/or mechanical processing steps. For example, the surface of the fibrous structure may be treated with a gas, a liquid, a polymer, and/or a coating material, followed by another heat treatment to modify the surface of the fibrous structure. The size of the fibrous structure may be controlled using a spinning machine.

In another embodiment, the fibrous structure may be prepared by an electrospinning process, followed by various heat treatments. The electrospinning process has been used to prepare fibrous structures with various materials, such as polymers, ceramics, and/or composites. The electrospinning process may yield uniform nanofibers ranging from 10 nm up to several micrometers. The electrospinning process may also help trigger a certain facet formation, such as enabling single crystalline nanofibers or polycrystalline materials in a bulk scale.

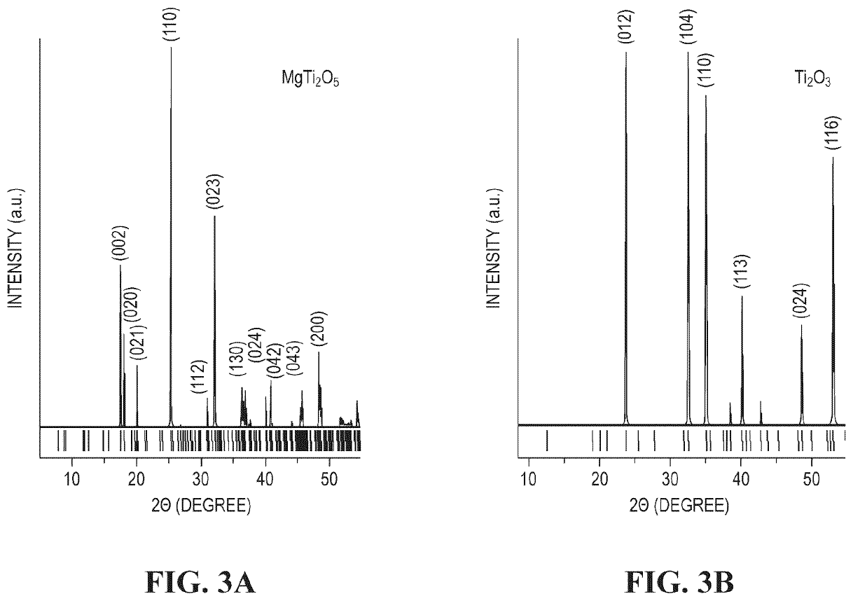

FIG. 3A depicts a calculated X-ray diffraction (XRD) pattern for orthorhombic MgTi₂O₅(Cmcm) phases. Cmcm represents a space group of the MgTi₂O₅ phases. FIG. 3A shows the XRD pattern of the MgTi₂O₅ phases in 10 to 50 degrees (2θ) range. FIG. 3B depicts a calculated X-ray diffraction (XRD) pattern for orthorhombic Ti₂O₃(R-3c) phases. R-3c represents a space group of the Ti₂O₃ phase. FIG. 3B shows the XRD pattern of the Ti₂O₃(R-3c) phases in 10 to 50 degrees (2θ) range. The XRD patterns in FIGS. 3A and 3B are calculated based on the known copper (Cu) K-α X-ray frequency, which corresponds to an X-ray wavelength of 1.5406 Å. The resolution of the XRD patterns may vary depending on factors such as an X-ray source, a current, a voltage, and/or a scan rate.

The XRD patterns may be used to determine phase purity and/or crystallinity of inorganic materials. As shown in FIG. 3A, the XRD pattern of the MgTi₂O₅ phases shows major peaks, for example, at (110), (023), (002), (020), (200), and (021). In FIG. 3B, the XRD pattern of the Ti₂O₃ phase shows major peaks, for example, at (012), (104) and (110). If the MgTi₂O₅ phases include impurities, additional or heightened peaks may be shown in the XRD pattern to indicate the presence of the impurities. The impurities may be introduced during the synthesis of the MgTi₂O₅. For example, if an excess amount of the Ti-containing precursors is used during the synthesis, impurities, including, but not limited to, Ti₂O₃, may exist in the MgTi₂O₅ phases. In that case, the XRD pattern of the MgTi₂O₅ phases may show peaks indicating the presence of Ti₂O₃. The impurities may also be Ti₃O, Ti₃O₅, Ti₂O, Ti₆O, TiO, TiO₂, Ti₄O₇, Ti₆O₁₁, Ti₅O₉, Ti₈O₁₃, Ti₁₉O₃₀, and/or Ti₁₃O₂₂.

To synthesize a mixed metal oxide material of Mg and Ti, i.e., Mg—Ti—O fibers, Mg- and Ti-containing precursors may be dissolved and mixed in a solvent (e.g. water or an organic solvent). The resulting mixture may be in a form of a solution, a gel, or a slurry. The mixture may be loaded onto a syringe. A high voltage power supply may be applied to the mixture to form electrospun fibers, which may then be collected and treated with heat in a furnace. For example, the electrospun fibers may be treated in a reducing environment at a temperature in a range of 400 to 1,500° C. for 1 to 48 hours. A reducing gas may be present in the reducing environment. The reducing gas may be nitrogen (N₂), argon (Ar), hydrogen (H₂), or a mixture thereof (e.g. Ar/H₂, etc.). An extra burnout process may be performed prior to or after the heat treatment. The burnout process may require 30 minutes to 24 hours at a moderate temperature below 500° C.

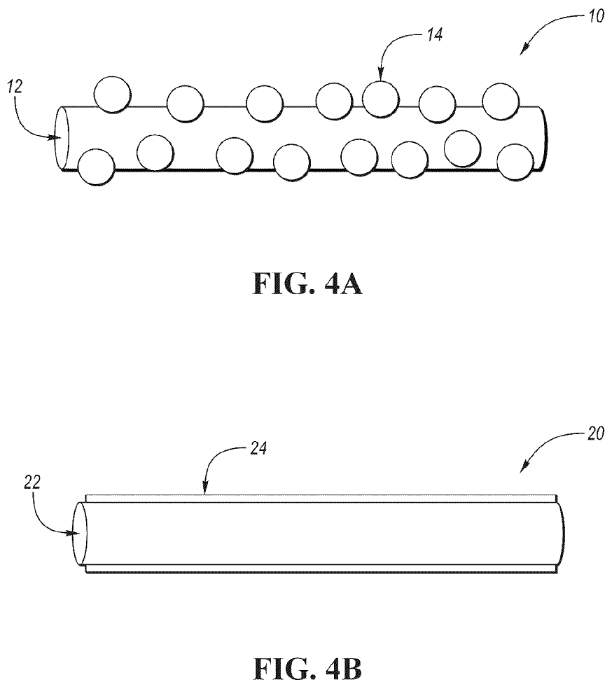

FIG. 4A depicts a schematic diagram of a first embodiment of a catalyst layer 10. The catalyst layer 10 may be a catalyst layer of an electrochemical cell. The electrochemical cell may be a fuel cell or electrolyzer. The catalyst layer 10 may include a catalyst support 12 supporting a catalyst material 14 thereon. The catalyst support 12 may include a catalyst support material. The catalyst support material may be an oxide material. The oxide material may be a mixed metal oxide material of metal elements. The catalyst support material may be prepared as described above. The catalyst material 14 may be Pt and/or Pt-M alloy, where M is a metal element other than Pt. As shown in FIG. 4A, the catalyst material 14 may be nanoparticles and supported on the catalyst support 12 at various locations.

FIG. 4B depicts a schematic diagram of a second embodiment of a catalyst layer 20. The catalyst layer 20 may be a catalyst layer of an electrochemical cell. The electrochemical cell may be a fuel cell or electrolyzer. The catalyst layer 20 may include a catalyst support 22 supporting a catalyst material 24 thereon. The catalyst support 22 may include a catalyst support material. The catalyst support material may be an oxide material. The oxide material may be a mixed metal oxide material of metal elements. The catalyst support material may be prepared as described above. The catalyst material 24 may be Pt and/or Pt-M alloy, where M is a metal element other than Pt. As shown in FIG. 4B, the catalyst material 24 may be a thin catalyst coating layer on the catalyst support 22.

In either FIG. 4A or FIG. 4B, the catalyst support material may have a fibrous structure. In some embodiments, the fibrous structure may be nanofibers. The nanofibers may have a diameter of 10 to 250 nm. The nanofibers may have an axial length of 50 nm to 950 nm. In some other embodiments, the fibrous structure may be microfibers. The microfibers may have a diameter of 50 nm to 5 μm. The microfibers may have an axial length of 500 nm to 500 μm.

Referring to FIGS. 4A and 4B, the catalyst support material may be a mixed metal oxide material of Mg and Ti. The mixed metal oxide material of Mg and Ti may have a general formula of MgₐTi_{b}O₅₋ₓ, where 0≤x≤3, and a and b are different. The mixed metal oxide material of Mg and Ti may have an electronic conductivity greater than 0.01 S/cm.

In one embodiment, a ratio of a to b is 0.5. The mixed metal oxide material of Mg and Ti may be MgTi₂O₅₋ₓ(0≤x≤3). The mixed metal oxide material of Mg and Ti may further include Ti—O impurities. The Ti—O impurities may be TiO, Ti₂O₃, TiO₂, or a combination thereof.

In another embodiment, a ratio of a to b may be greater than 0.01 and less than 0.5, i.e. 0.01<a/b<0.5. Specifically, the mixed metal oxide material of Mg and Ti may be Mg_{1-d}Ti_{2+d}O₅, where 0<d<1. The mixed metal oxide material of Mg and Ti may be, but not limited to, Mg_{0.4}Ti_{2.6}O₅, Mg_{0.5}Ti_{2.5}O₅, Mg_{0.6}Ti_{2.4}O₅, Mg_{0.7}Ti_{2.3}O₅, Mg_{0.8}Ti_{2.2}O₅, or Mg_{0.9}Ti_{2.1}O₅. The mixed metal oxide material of Mg and Ti may also be, but not limited to, Mg₃Ti₉O₂₀, MgTi₅O₁₀, Mg₂Ti₇O₁₅, Mg₅Ti₁₃O₂₀, or Mg₁₁Ti₂₅O₆₀. The mixed metal oxide material of Mg and Ti may further include Ti—O impurities. The Ti—O impurities may be TiO, Ti₂O₃, TiO₂, or a combination thereof.

In yet another embodiment, a ratio of a to b may be greater than 0.5 and less than 0.8, i.e. 0.5<a/b<0.8.

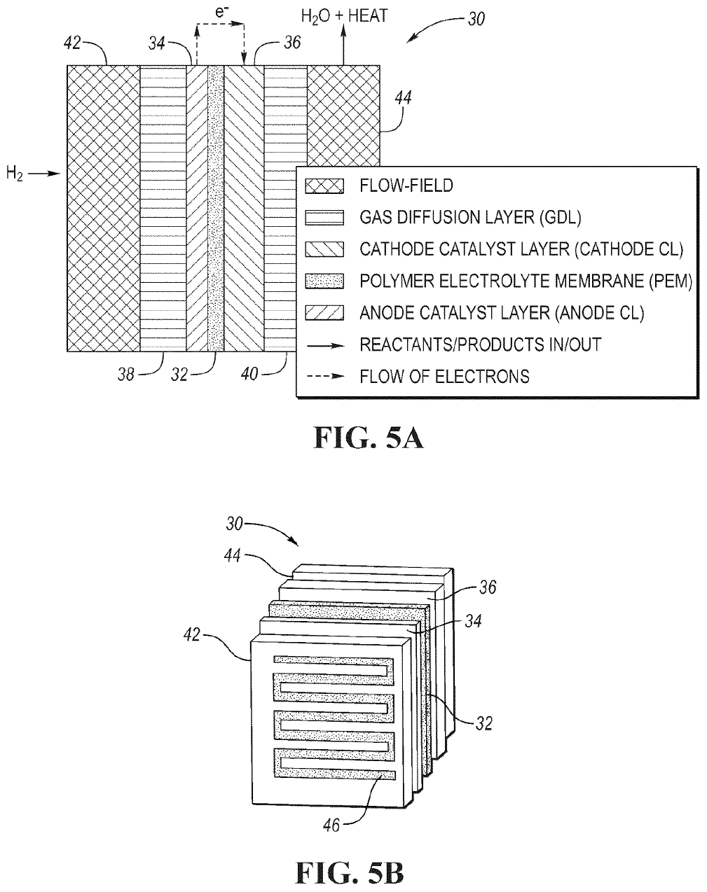

FIG. 5A is a schematic cross-sectional view of a fuel cell according to one embodiment of the present disclosure. FIG. 5B is a schematic perspective view of components of the fuel cell shown in FIG. 5A. FIG. 5A also generally depicts the reactants and products of the operation of the fuel cell. The fuel cell 30 may be a PEM fuel cell. As shown in FIG. 5A, the fuel cell 30 includes a PEM 32, a first catalyst layer 34 and a second catalyst layer 36. The PEM 32 is situated between the first and second catalyst layers, 34 and 36. The fuel cell 30 further includes a first GDL 38 surrounds the first catalyst layer 34, and a second GDL 40 surrounds the second catalyst layer 36. The fuel cell 30 also includes a first bipolar plate 42 and a second bipolar plate 44. The first and second bipolar plates, 42 and 44, are positioned at opposite ends of the fuel cell 30 and surround the first and second GDLs, 38 and 40, respectively. The first and second bipolar plates, 42 and 44, are typically formed of a metal substrate, such as steel or stainless steel, and have at least one surface.

The first and second bipolar plates, 42 and 44, may provide structural support and conductivity, and may assist in supplying fuel and oxidants (air) in the fuel cell 30. The first and second bipolar plates, 42 and 44, may also assist in removal of reaction products or byproducts from the fuel cell 30. As shown in FIG. 5B, the first bipolar plate 42 includes a flow passage 46. The second bipolar plate 44 also includes a flow passage (not shown). The flow passages are configured to assist in supplying fuel and/or removing by-products in the fuel cell 30.

Referring to FIG. 5A, each of the first and second catalyst layers 34 and 36 includes a catalyst support supporting a catalyst material thereon. Each of the first and second catalyst layer 34 and 36 may be the catalyst layer 10 in FIG. 4A or the catalyst layer 20 in FIG. 4B. The catalyst support includes a catalyst support material. The catalyst support material may be an oxide material. The oxide material may be a mixed metal oxide material of metal elements. The catalyst support material may have a fibrous structure. In some embodiments, the fibrous structure may be nanofibers. The nanofibers may have a diameter of 10 to 250 nm. The nanofibers may have an axial length of 50 nm to 950 nm. In some other embodiments, the fibrous structure may be microfibers. The microfibers may have a diameter of 50 nm to 5 μm. The microfibers may have an axial length of 500 nm to 500 μm.

In FIG. 5A, the catalyst support material may be a mixed metal oxide material of Mg and Ti. The mixed metal oxide material of Mg and Ti may have a general formula of MgₐTi_{b}O₅₋ₓ, where 0≤x≤3, and a and b may be different. The mixed metal oxide material of Mg and Ti may have an electronic conductivity greater than 0.01 S/cm. In one embodiment, a ratio of a to b is 0.5. The mixed metal oxide material of Mg and Ti may be MgTi₂O₅₋ₓ(0≤x≤3). The mixed metal oxide material of Mg and Ti may further include Ti—O impurities. The Ti—O impurities may be TiO, Ti₂O₃, TiO₂ or a combination thereof. In another embodiment, a ratio of a to b may be greater than 0.01 and less than 0.5, i.e. 0.01<a/b<0.5. In yet another embodiment, a ratio of a to b may be greater than 0.5 and less than 0.8, i.e. 0.5<a/b<0.8. The ratio of a:b may be any of the following values or in a range of any two of the following values: 0.01, 0.1, 0.2, 0.25, 0.3, 0.4, 0.5, 0.6, 0.7, 0.75, 0.8, 0.9, 0.99, 1.0, 1.1, 1.2, 1.3, 1.4, 1.5, 1.6, 1.7, 1.8, 1.9, and 2.0. x may be any of the following values or in a range of any two of the following values: 0, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, and 3.0.

The mixed metal oxide material of Mg and Ti may be Mg_{1-d}Ti_{2+d}O₅, where 0<d<1. The mixed metal oxide material of Mg and Ti may be, but not limited to, Mg_{0.4}Ti_{2.6}O₅, Mg_{0.5}Ti_{2.5}O₅, Mg_{0.6}Ti_{2.4}O₅, Mg_{0.7}Ti_{2.3}O₅, Mg_{0.8}Ti_{2.2}O₅, or Mg_{0.9}Ti_{2.1}O₅. The mixed metal oxide material of Mg and Ti may also be, but not limited to, Mg₃Ti₉O₂₀, MgTi₅O₁₀, Mg₂Ti₇O₁₅, Mg₅Ti₁₃O₂₀, or Mg₁₁Ti₂₅O₆₀. The mixed metal oxide material of Mg and Ti may further include Ti—O impurities. The Ti—O impurities may be TiO, Ti₂O₃, TiO₂ or a combination thereof.

Still referring to FIG. 5A, the catalyst material may be Pt and/or Pt-M alloy, where M is a metal element other than Pt. In some embodiments, the catalyst material may be nanoparticles and supported on the catalyst support at various locations. In some other embodiments, the catalyst material may be a thin catalyst coating layer on the catalyst support.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An electrochemical cell catalyst support comprising:
a fibrous catalyst support material, the fibrous catalyst support material being a mixed metal oxide material of magnesium (Mg) and titanium (Ti) with a general formula of MgₐTi_{b}O₅₋ₓ, where 0≤x≤3, and a ratio of a to b is greater than 0.01 and less than 2.0.

2. The electrochemical cell catalyst support of claim 1, wherein the mixed metal oxide material of Mg and Ti is Mg_{0.4}Ti_{2.6}O₅, Mg_{0.5}Ti_{2.5}O₅, Mg_{0.6}Ti_{2.4}O₅, Mg_{0.7}Ti_{2.3}O₅, Mg_{0.8}Ti_{2.2}O₅, or Mg_{0.9}Ti_{2.1}O₅, Mg₃Ti₉O₂₀, MgTi₅O₁₀, Mg₂Ti₇O₁₅, Mg₅Ti₁₃O₂₀, or Mg₁₁Ti₂₅O₆₀.

3. The electrochemical cell catalyst support of claim 1, wherein the mixed metal oxide material of Mg and Ti is MgTi₂O₅₋ₓ (0≤x≤3).

4. The electrochemical cell catalyst support of claim 1, wherein the mixed metal oxide material of Mg and Ti further includes TiO, Ti₂O₃, TiO₂, or a combination thereof.

5. The electrochemical cell catalyst support of claim 1, wherein the mixed metal oxide material of Mg and Ti has an electronic conductivity greater than 0.01 S/cm.

6. The electrochemical cell catalyst support of claim 1, wherein the fibrous catalyst support material has a fibrous structure, the fibrous structure being a nanofiber having a diameter of 10 to 250 nm and an axial length of 50 nm to 950 nm.

7. The electrochemical cell catalyst support of claim 1, wherein the fibrous catalyst support material has a fibrous structure, the fibrous structure being a microfiber having a diameter of 50 nm to 5 μm and an axial length of 500 nm to 500 μm.

8. An electrochemical cell catalyst layer comprising:
a catalyst material; and
a catalyst support supporting the catalyst material, the catalyst support having a catalyst support material, the catalyst support material being a mixed metal oxide material of magnesium (Mg) and titanium (Ti) with a general formula of MgₐTi_{b}O₅₋ₓ, where 0≤x≤3, and a ratio of a to b is not 0.5.

9. The electrochemical cell catalyst layer of claim 8, wherein the catalyst material is platinum (Pt) and/or Pt-M alloy, where M is a metal element other than Pt.

10. The electrochemical cell catalyst layer of claim 8, wherein the ratio of a to b is greater than 0.01 and less than 0.5.

11. The electrochemical cell catalyst layer of claim 10, wherein the mixed metal oxide material of Mg and Ti is Mg_{0.4}Ti_{2.6}O₅, Mg_{0.5}Ti_{2.5}O₅, Mg_{0.6}Ti_{2.4}O₅, Mg_{0.7}Ti_{2.3}O₅, Mg_{0.8}Ti_{2.2}O₅, or Mg_{0.9}Ti_{2.1}O₅.

12. The electrochemical cell catalyst layer of claim 10, wherein the mixed metal oxide material of Mg and Ti is Mg₃Ti₉O₂₀, MgTi₅O₁₀, Mg₂Ti₇O₁₅, Mg₅Ti₁₃O₂₀, or Mg₁₁Ti₂₅O₆₀.

13. The electrochemical cell catalyst layer of claim 8, wherein the ratio of a to b is greater than 0.5 and less than 0.8.

14. The electrochemical cell catalyst layer of claim 8, wherein the mixed metal oxide material of Mg and Ti further includes TiO, Ti₂O₃, TiO₂, or a combination thereof.

15. The electrochemical cell catalyst layer of claim 8, wherein the mixed metal oxide material of Mg and Ti has an electronic conductivity greater than 0.01 S/cm.

16. The electrochemical cell catalyst layer of claim 8, wherein the catalyst support material has a fibrous structure, the fibrous structure being a nanofiber having a diameter of 10 to 250 nm and an axial length of 50 nm to 950 nm.

17. The electrochemical cell catalyst layer of claim 8, wherein the catalyst support material has a fibrous structure, the fibrous structure being a microfiber having a diameter of 50 nm to 5 μm and an axial length of 500 nm to 500 μm.

18. An electrochemical cell comprising:
a first catalyst layer and a second catalyst layer, each of the first and second catalyst layers having a catalyst support supporting a catalyst material, the catalyst support having a catalyst support material, the catalyst support material being a mixed metal oxide material of magnesium (Mg) and titanium (Ti) with a general formula of MgₐTi_{b}O₅₋ₓ, where 0≤x≤3, and a ratio of a to b is not 0.5; and
an electrolyte membrane situated between the first and second catalyst layers.

19. The electrochemical cell of claim 18, wherein the catalyst support material has a fibrous structure, the fibrous structure being a nanofiber having a diameter of 10 to 250 nm and an axial length of 50 nm to 950 nm.

20. The electrochemical cell of claim 18, wherein the catalyst support material has a fibrous structure, the fibrous structure being a microfiber having a diameter of 50 nm to 5 μm and an axial length of 500 nm to 500 μm.
